(19) United States
(12) Patent Application Publication
(10) Pub. No.: US 2010/0039208 A1
(43) Pub. Date: Feb. 18, 2010

(54) HIGH-FREQUENCY, THIN-FILM LIQUID CRYSTAL THERMAL SWITCHES

(76) Inventors: Richard I. EPSTEIN, Santa Fe, MN (US); Kevin J. MALLOY, Albuquerque, MN (US); Mansoor SHEIK-BAHAE, Albuquerque, MN (US)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/354,469

(22) Filed: Jan. 15, 2009

Related U.S. Application Data
(60) Provisional application No. 61/021,188, filed on Jan. 15, 2008.

(51) Int. Cl. H01H 37/02

(52) U.S. Cl. 337/21

(57) ABSTRACT

In accordance with the invention, there are thermal switches, method of operating thermal switches and methods of forming thermal switches. A thermal switch can include a thin layer of liquid crystal disposed between a first surface of a first insulating substrate and a second surface of a second insulating substrate, wherein the liquid crystals are aligned at one or more of the first surface and the second surface due to surface preparation.

### RELATED APPLICATIONS

This application claims priority from U.S. Provisional Patent Application Ser. No. 611021,188, filed Jan. 15, 2008 which is hereby incorporated by reference in its entirety.

### GOVERNMENT RIGHTS

This invention was made with government support under Contract No. FA9550-04-1-0356 awarded by the Air Force Office of Scientific Research, The government has certain rights in the invention.

### DESCRIPTION OF THE INVENTION

1. Field of the Invention

The subject matter of this invention relates to thermal switches. More particularly, the subject matter of this invention relates to devices and methods of making high-frequency, thin-film liquid-crystal thermal switches.

2. Background of the Invention

Physical processes such as the electrocaloric, magnetocaloric, and pyroelectric effects can be inherently efficient (i.e. low hysteresis) and may be the basis for devices for the economic conversion of heat into electrical power or for efficient refrigeration and air conditioning. However, these physical effects are best realized in thin films having a thickness of few microns or less. For films of these thicknesses, the thermal diffusion time scale is in the millisecond range. To exploit the benefits of these efficient physical processes, one needs rugged reliable thermal switches that can respond on comparable time scales. Currently, there are no techniques for rapidly changing the thermal conductivity between thin films of various materials. No mechanical thermal switches, including MEMS devices, can function reliably at these rates over the desired operational lifetime. This deficiency has limited the development of efficient refrigeration and energy generation devices utilizing electrocaloric, magnetocaloric, or pyroelectric thin films.

Hence, there is a need for high-frequency, thin-film thermal switches.

### SUMMARY OF THE INVENTION

In accordance with the present teachings, there is a thermal switch including a first electrically insulating substrate and a second electrically insulating substrate. The thermal switch can also include a thin layer of liquid crystal disposed between a first surface of the first insulating substrate and a second surface of the second insulating substrate, wherein the liquid crystals are aligned at one or more of the first surface and the second surface due to surface preparation.

According to various embodiments, there is a method of forming a thermal switch. The method can include forming one or more pairs of first interdigitated electrodes on a first surface of a first insulating substrate, wherein each of the one or more pairs of first interdigitated electrodes can include a plurality of first electrodes. The method can also include forming one or more pairs of second interdigitated electrodes on a second surface of a second insulating substrate, wherein each of the one or more pairs of second interdigitated electrodes can include a plurality of second electrodes. The method can further include forming a thin layer of liquid crystal between the first surface of the first insulating substrate and the second surface of the second insulating substrate and providing one or more power supplies to apply a voltage between one or more of the first electrodes, between one or more of the second electrodes, and between the one or more pairs of first interdigitated electrodes and the one or more pairs of second interdigitated electrodes.

According to another embodiments, there is a method of operating a thermal switch including providing a thermal switch, wherein the thermal switch can include a thin layer of liquid crystal disposed between a first surface of a first electrically insulating substrate and a second surface of a second electrically insulating substrate, wherein the liquid crystals are aligned at one or more of the first surface and the second surface due to surface preparation. The method of operating a thermal switch can also include closing the thermal switch such that a director of the liquid crystal is aligned perpendicular to one or more of the first surface and the second surface.

Additional objects and advantages of the invention will be set forth in part in the description which follows, and in part will be obvious from the description, or may be learned by practice of the invention The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

FIG. 1 shows a schematic illustration of an exemplary thermal switch in an open state, according to various embodiments of the present teachings.

FIG. 2 shows a schematic. illustration of an exemplary pair of interdigitated electrodes, according to various embodiments of the present teachings.

FIG. 3 shows a schematic illustration of an exemplary thermal switch in a closed state, according to various embodiments of the present teachings.

### DESCRIPTION OF THE EMBODIMENTS

Reference will now be made in detail to the present embodiments, examples of which are illustrated in the accompanying drawings. Wherever possible, the same reference numbers will be used throughout the drawings to refer to the same or like parts.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values In this case, the example value of range stated as “less that 10” can assume negative values, e.g. −1, −2, −3, −10, −20, −30, etc.

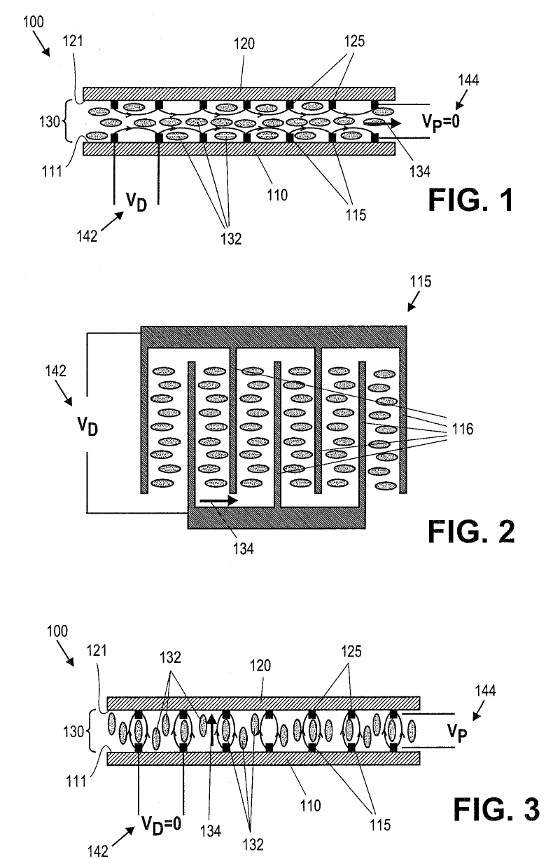

FIG. 1 shows a schematic illustration of an exemplary thermal switch 100, according to various embodiments of the present teachings. The thermal switch 100 can include a include a thin layer 130 of liquid crystal 132 disposed between a first surface 111 of the first electrically insulating substrate 110 and a second surface 121 of a second electrically insulating substrate 120, as shown in FIGS. 1 and 3. In various embodiments, the liquid crystals 132 can be aligned at one or more of the first surface 111 and the second surface 121 due to surface 111, 121 preparation One of ordinary skill in the art would know that the surface 111, 121 preparation can be chemical and/or physical.

In some embodiments, the thermal switch 100 can also include one or more pairs of first interdigitated electrodes 115 on the first surface 111 and one or more pairs of second interdigitated electrodes 125 on the second surface 121, as shown in FIGS. 1 and 3. In various embodiments, each of the one or more pairs of first interdigitated electrodes 115 can include a plurality of first electrodes 116, as shown in FIG. 2. In some embodiments, each of the one or more pairs of second interdigitated electrodes 125 can have a structure as shown in FIG. 2 and can include a plurality of second electrodes 126 (not shown) in a configuration as that of first electrodes 116. Any suitable material can be used for the first and the second insulating substrates 110, 120, such as, for example, any form of glass, any suitable rigid polymer, and any suitable flexible polymer that when used in a multilayer configuration can provide structural rigidity. In various embodiments, the first and the second insulating substrates 110, 120 can have a thickness from about 10 μm to about 500 μm and in some cases from about 100 tm to about 500 tm. The first electrodes 116 and the second electrodes 126 can include any suitable material, including metals, such as, for example, gold and aluminum and conductive oxides, such as for example, indium tin oxide (ITO). In some embodiments, the first interdigitated electrodes 115 and the second interdigitated electrodes 125 can have a width from about 0.1 μm to about 10 μm and can be spaced from about 1 μm to about 30 μm apart.

In various embodiments, the liquid crystal 132 can have anisotropic thermal conductivity. As used herein, the term “anisotropic thermal conductivity” means different thermal conductivities in the direction perpendicular and parallel to the director 134 of the liquid crystal 132. The ratio of these thermal conductivities has been measured and can be larger than about 3. Exemplary liquid crystal 132 can include, but are not limited to ZL1-2806 and MLC-2011 (Merck, Japan). In various embodiments, the thin layer 130 of liquid crystal 132 can have a thickness from about 1 μm to about 20 μm and in some cases from about 5 μm to about 15 μm. In some embodiments, the thin layer 130 of liquid crystal 132 can include a plurality of carbon nanotubes. While not intending to be bound by any specific theory, it is believed that the addition of carbon nanotubes can further enhance the anisotropy of the thermal conductivity of the thin layer 130 of liquid crystal 132.

The thermal switch 100 can further include one or more power supplies 142, 144 to apply a voltage between one or more of the first electrodes 116, between one or more of the second electrodes 126, or between the one or more pairs of first interdigitated electrodes 115 and the one or more pairs of second interdigitated electrodes 125.

In various embodiments, there can be a pyroelectric device including the thermal switch 100 for extracting electrical energy from a surface that can be at a temperature different from its surrounding environment. In some embodiments, the surface can be from an automobile surface. In other embodiments, the pyroelectric device for harvesting electrical energy can be integrated into the radiators and/or exhaust of automobiles, which in turn can increase the automobile efficiency and eliminate need for generators or alternators. In some other embodiments, the surface can be a furnace. In certain embodiments, the surface can be a human body.

In some embodiments, the thermal switch 100 can include a plurality of thermotropic liquid crystals, such as, for example, para-Azoxyanisole (PAA). The exemplary para-Azoxyanisole liquid crystal has liquid crystal range from 118° C. to 136° C. with the nematic to isotropic liquid transition at 136° C.

In various embodiments, there can be a thin film based refrigeration system including the thermal switch 100, wherein the refrigeration system can use one or more of magnetocaloric effect and electrocaloric effect. In certain embodiments, a thin film based air conditioning system can include the thermal switch 100, wherein the air conditioning system can use one or more of magnetocaloric effect and electrocaloric effect. In some embodiments, a temperature regulator can include the thermal switch 100 for regulating the temperature of electronic devices and detectors. In various embodiments, the temperature regulator can provide high frequency temperature controls over both small and large areas, which could be useful for sensitive detectors such as, infrared cameras used for national security and nonproliferation monitoring as well as for computer processors. The thin film based refrigeration system including the thermal switch 100 of the present disclosure would be compact, potentially more efficient and cost-effective than current vapor-compression devices, which are in widespread use.

According to various embodiments of the present teachings there is a method of forming a thermal switch 100. The method can include forming one or more pairs of first interdigitated electrodes 115 on a first surface 111 of a first insulating substrate 110, wherein each of the one or more pairs of first interdigitated electrodes 115 can include a plurality of first electrodes 116. The method can also include forming one or more pairs of second interdigitated electrodes 125 on a second surface 121 of a second insulating substrate 120, wherein each of the one or more pairs of second interdigitated electrodes 125 can include a plurality of second electrodes 126. Any suitable method can be used for the formation of the first pair 115 and the second pair 125 of interdigitated electrodes, such as, for example, standard photolithography. In some embodiments, the first interdigitated electrodes 115 and the second interdigitated electrodes 125 can have a width from about 0.1 μm to about 10 μm and can be spaced from about 1 μm to about 30 μm apart.

The method of forming a thermal switch 100 can further include forming a thin layer 130 of liquid crystal 132 between the first surface 111 of the first insulating substrate 110 and the second surface 121 of the second insulating substrate 120, wherein the liquid crystal 130 can have an anisotropic thermal conductivity. Exemplary liquid crystal 132 can include, but are not limited to ZL1-2806 and MLC-2011 (Merck, Japan). In various embodiments, the step of forming a thin layer 130 of liquid crystal 132 can further include adding a plurality of carbon nanotubes to the thin layer 130 of liquid crystal 132. Addition of carbon nanotubes to the thin layer of liquid crystal can further increase the anisotropy of thermal conductivities of the thin layer 130 of liquid crystal 132. In certain embodiments, the step of forming a thin layer 130 of liquid crystal 132 can include forming a thin layer 130 of a plurality of thermotropic liquid crystals 132, such as, for example, para-Azoxyanisole (PAA). However, any other suitable thermotropic liquid crystal 132 can be used to form the thin layer 130.

The method of forming a thermal switch 100 can also include providing one or more power supplies 142, 144 to apply a voltage between one or more of the first electrodes 116, between one or more of the second electrodes 126, and between the one or more pairs of first interdigitated electrodes 115 and the one or more pairs of second interdigitated electrodes 125.

According to various embodiments, there is a method of operating a thermal switch 100, as shown in FIG. 1 and 2. The method can include providing the thermal switch 100. As described earlier, the thermal switch 100 can include a thin layer 130 of liquid crystal 132 disposed between a first surface 111 of the first electrically insulating substrate 110 and a second surface 121 of a second electrically insulating substrate 120, wherein the liquid crystals 132 can be aligned at one or more of the first surface 111 and the second surface 121. The method of operating a thermal switch 100 can also include closing the thermal switch 100, such that a director of the liquid crystal is aligned perpendicular to the one or more of the first surface 111 and the second surface 121.

In various embodiments, the step of providing the thermal switch 100 can include providing the thermal switch 100, the thermal switch 100 including a plurality of thermotropic liquid crystals and the step of closing the thermal switch 100 can include changing the temperature of the thin layer 130 of the plurality of s 132.

In some embodiments, the first surface 111 further can further include one or more pairs of first interdigitated electrodes 115 on the first surface 111 of the first insulating substrate 110, wherein each of the one or more pairs of first interdigitated electrodes 115 can include a plurality of first electrodes 116. In other embodiments, the second surface 121 can include one or more pairs of second interdigitated electrodes 125 on the second surface 121 of the second insulating substrate 120, wherein each of the one or more pairs of second interdigitated electrodes 125 can include a plurality of second electrodes 126 (not shown). In various embodiments, the step of closing the thermal switch 100 can also include applying a voltage between the one or more first electrodes 116 of the plurality of first electrodes 116, such that a director 134 of the liquid crystal 132 is aligned parallel to the first surface 111, as shown in FIG. 1, thereby resulting in a decrease in the thermal conductivity across the thin layer 130 of liquid crystal 132. In other embodiments, the method of operating a thermal switch 100 can also include opening the thermal switch 100 by applying a voltage between the one or more second electrodes 126 of the plurality of first electrodes 126, such that a director 134 of the liquid crystal 132 is aligned parallel to the first surface 121, thereby resulting in a decrease in the thermal conductivity across the thin layer 130 of liquid crystal 132. In some other embodiments, the step of closing the thermal switch 100 can further include applying a voltage between the one or more pairs of first interdigitated electrodes 115 and the one or more pairs of second interdigitated electrodes 125, such that a director 134 of the liquid crystal 132 is aligned perpendicular to the first 111 and the second 121 surface, thereby resulting in an increase in the thermal conductivity across the thin layer 130 of liquid crystal 132. One of ordinary skill in the art would know that the rate at which the director 134 of the liquid crystal 132 shifts is proportional to the square of the applied electric field. The directors of exemplary liquid crystals, such as, ZL1-2806 and MLC-2011 can reorient in about 0.1 milliseconds when a voltage of about 100V is applied. Liquids crystals of lower viscosity can be switched even more quickly. In some embodiments, the closing and/or opening of the thermal switch can occur in less than about 1 second at an applied voltage of about 100 V or less, and in some cases in less than about 0.1 second at an applied voltage of about 100 V or less, and in some other cases in less than about 5 millisecond at an applied voltage of about 100 V or less.

Additionally, rapid thermal switching can be used to control the heat flow in device such as computer chips and optical focal planes. Thermal switches could be used to eliminate hot spots or to ensure highly uniform temperatures over large areas.

While the invention has been illustrated respect to one or more implementations, alterations and/or modifications can be made to the illustrated examples without departing from the spirit and scope of the appended claims. In addition, while a particular feature of the invention may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.” As used herein, the term “one or more of” with respect to a listing of items such as, for example, A and B, means A alone, B alone, or A and B. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A thermal switch comprising:
a first electrically insulating substrate;
a second electrically insulating substrate; and
a thin layer of liquid crystal disposed between a first surface of the first insulating substrate and a second surface of the second insulating substrate, wherein the liquid crystals are aligned at one or more of the first surface and the second surface due to surface preparation.

2. The thermal switch of claim 1 further comprising:
one or more pairs of first interdigitated electrodes on the first surface of the first insulating substrate, wherein each of the one or more pairs of first interdigitated electrodes comprises a plurality of first electrodes; and
one or more pairs of second interdigitated electrodes on the second surface of the second insulating substrate, wherein each of the one or more pairs of second interdigitated electrodes comprises a plurality of second electrodes.

3. The thermal switch of claim 2, wherein the liquid crystal has anisotropic thermal conductivity.

4. The thermal switch of claim 2, wherein the thin layer of liquid crystal comprises a plurality of carbon nanotubes.

5. The thermal switch of claim 2, wherein the liquid crystal has anisotropic thermal conductivity of greater than about 3.

6. The thermal switch of claim 2 further comprising one or more power supplies to apply a voltage between one or more of the first electrodes, between one or more of the second electrodes, and between the one or more pairs of first interdigitated electrodes and the one or more pairs of second interdigitated electrodes.

7. A pyroelectric device comprising the thermal switch of claim 2 for extracting electrical energy from a surface that is at a temperature different from its surrounding environment.

8. The thermal switch of claim 1, wherein the liquid crystal comprises a plurality of thermotropic liquid crystals.

9. A thin film based refrigeration system comprising the thermal switch of claim 1, wherein the refrigeration system uses one or more of magnetocaloric effect and electrocaloric effect.

10. A thin film based air conditioning system comprising the thermal switch of claim 1, wherein the air conditioning system uses one or more of magnetocaloric effect and electrocaloric effect.

11. A method of forming a thermal switch comprising:
forming one or more pairs of first interdigitated electrodes on a first surface of a first insulating substrate, wherein each of the one or more pairs of first interdigitated electrodes comprises a plurality of first electrodes;
forming one or more pairs of second interdigitated electrodes on a second surface of a second insulating substrate, wherein each of the one or more pairs of second interdigitated electrodes comprises a plurality of second electrodes;
forming a thin layer of liquid crystal between the first surface of the first insulating substrate and the second surface of the second insulating substrate; and
providing one or more power supplies to apply a voltage between one or more of the first electrodes, between one or more of the second electrodes, and between the one or more pairs of first interdigitated electrodes and the one or more pairs of second interdigitated electrodes.

12. The method of forming a thermal switch, according to claim 11, wherein the step of forming a thin layer of liquid crystal comprises forming a thin layer of liquid crystal having anisotropic thermal conductivity.

13. The method of forming a thermal switch, according to claim 12 wherein the step of forming a thin layer of liquid crystal further comprises adding a plurality of carbon nanotubes to the thin layer of liquid crystal.

14. The method of forming a thermal switch, according to claim 11, wherein the step of forming a thin layer of liquid crystal comprises forming a thin layer of a plurality of thermotropic liquid crystals.

15. A method of operating a thermal switch comprising:
providing a thermal switch, wherein the thermal switch comprises a thin layer of liquid crystal disposed between a first surface of a first electrically insulating substrate and a second surface of a second electrically insulating substrate, wherein the liquid crystals are aligned at one or more of the first surface and the second surface due to surface preparation; and
closing the thermal switch such that a director of the liquid crystal is aligned perpendicular to one or more of the first surface and the second surface.

16. The method of operating a thermal switch according to claim 15, wherein the first surface further comprises one or more pairs of first interdigitated electrodes, and the second surfaces further comprises one or more pairs of second interdigitated electrodes, each of the one or more pairs of first and second interdigitated electrodes comprising a plurality of first and second electrodes respectively.

17. The method of operating a thermal switch, according to claim 16, wherein the step of closing the thermal switch comprises applying a voltage between the one or more pairs of first interdigitated electrodes and the one or more pairs of second interdigitated electrodes.

18. The method of operating a thermal switch, according to claim 16 wherein the step of closing the thermal switch comprises closing the thermal switch in less than about 1 second at an applied voltage of about 100 V or less.

19. The method of operating a thermal switch, according to claim 16 wherein the step of closing the thermal switch comprises closing the thermal switch in less than about 5 millisecond at an applied voltage of about 100 V or less.

20. The method of operating a thermal switch, according to claim 16 further comprises opening the thermal switch by applying a voltage between the one or more first electrodes of the plurality of first electrodes, such that the director of the liquid crystal is aligned parallel to the first surface.

21. The method of operating a thermal switch, according to claim 16 further comprises opening the thermal switch by applying a voltage between the one or more second electrodes of the plurality of second electrodes, such that the director of the liquid crystal is aligned parallel to the second surface,

22. The method of operating a thermal switch, according to claim 15 wherein the thermal switch further comprises a plurality of thermotropic liquid crystals.

23. The method of operating a thermal switch, according to claim 22, wherein the step of closing the thermal switch comprises changing the temperature of the thin layer of liquid crystal.
